(19) United States
(12) Patent Application Publication
(10) Pub. No.: US 2017/0066669 A1
(43) Pub. Date: Mar. 9, 2017

(54) INTEGRATED HYDRODYNAMIC SEPARATOR (HDS) STRUCTURE, EFFLUENT CHANNEL FOR SEPARATING MIXED LIQUOR SUSPENDED SOLIDS (MLSS) IN WASTEWATER TREATMENT

(71) Applicant: Palo Alto Research Center Incorporated, Palo Alto, CA (US)

(72) Inventors: Cory Lancaster, Palo Alto, CA (US); Armin R. Volkel, Mountain View, CA (US)

(73) Assignee: Palo Alto Research Center Incorporated, Palo Alto, CA (US)

(21) Appl. No.: 14/844,416

(22) Filed: Sep. 3, 2015

(51) Int. Cl. C02F 3/12

(52) U.S. Cl. CPC C02F 3/121; C02F 2203/00

(57) ABSTRACT

A method and system for a wastewater treatment plant to include a hydrodynamic separator (HDS) arrangement in association with an aeration basin effluent channel as an input, and the output of an HDS arrangement which are not bifurcated and a splitting of the output from the HDS arrangement is achieved by use of a removable and movable splitter.

### BACKGROUND

Presently, wastewater treatment plants employ multiple steps in processing wastewater to meet effluent water quality requirements. Examples of such plants are discussed in U.S. Pat. No. 8,268,169 B2, titled “Membrane Bioreactor (MBR) and Moving Bed Bioreactor (MBBR) Configurations for Wastewater Treatment”, and U.S. Patent Publication 2015/0175454 A1, titled “Recycling Activated Sludge by Hydrodynamic Separator (HDS) to Enable High MLSS Bioreactor to Process High Influent Flow and/or High Strength Wastewater.”

In wastewater treatment plant design for suspended growth activated sludge systems, the end of aeration basins are often outfit with weirs and effluent channels for hydraulic control and solids distribution purposes. From effluent channels the mixed liquor suspended solids (MLSS, or activated sludge) are sent to clarifiers or membrane bioreactors (MBRs) for solids separation. The thickened MLSS or activated sludge solids from these devices are either recycled back to seed the influent wastewater, or are wasted. Clarified effluent is disinfected and discharged. Clarifiers and MBRs are sized to accommodate certain concentrations and flow rates (solids flux).

It is considered useful to design a wastewater treatment plant which lowers the concentration of MLSS or activated sludge provided to operational units that act to separate MLSS or activated sludge solids, e.g., clarifiers, MBRs, etc. of the treatment plant. This allows for a significant reduction in the size and/or number of such operational units, in turn permitting for a more compact and efficient wastewater treatment plant.

### INCORPORATION BY REFERENCE

The following articles, and co-pending and commonly assigned applications, the disclosures of each being totally incorporated herein by reference, are mentioned:

U.S. Published Application Publication No. 2009/0050538, entitled, “Serpentine Structures for Continuous Flow Particle Separations”, by Lean et al:; U.S. Published Application Publication No. 2008/0128331, entitled, “Particle Separation and Concentration System”, by Lean et al.; U.S. Published Application Publication No. 2008/0230458, entitled, “Vortex Structure for High Throughput Continuous Flow Separation”, by Lean et al.; U.S. Published Application Publication No. 2009/0114601, entitled, “Device and Method for Dynamic Processing in Water Purification”, by Lean et al.; U.S. Published Application Publication No. 2009/0114607, entitled, “Fluidic Device and Method for Separation of Neutrally Buoyant Particles”, by Lean et al.; U.S. Pat. No. 8,404,093, entitled, “Flow De-Ionization Using Independently Controlled Voltages”, by Armin R. Volkel et al.; U.S. Patent Application Publication No. 2010/0314323, entitled, “Method and Apparatus for Continuous Flow Membrane-Less Algae Dewatering”, by Lean et al.; U.S. Published Application Publication No. 2009/0283455, entitled, “Fluidic Structures for Membraneless Particle Separation”, by Lean et al.; U.S. Pat. No. 8,931,644 B2, entitled “Method and Apparatus for Splitting Fluid Flow in a Membraneless Particle Separation System”, by Lean et al.; U.S. Patent Application Publication No. 2011/0108491, entitled, “Desalination Using Supercritical Water and Spiral Separation”, by Lean et al.; U.S. Published Application Publication No. 2010/0072142, entitled, “Method and System for Seeding with Mature Floc to Accelerate Aggregation in a Water Treatment Process”, by Lean et al.; U.S. Patent Application Publication No. 2010/0314263, entitled, “Stand-Alone Integrated Water Treatment System for Distributed Water Supply to Small Communities”, by Lean et al.; U.S. Patent Application Publication No. 2010/0314325, entitled, “Spiral Mixer for Floc Conditioning”, by Lean et al.; U.S. Patent Application Publication No. 2010/0314327, entitled, “Platform Technology for Industrial Separations”, by Lean et al.; U.S. Patent Application Publication No. 2012/0145647, entitled, “Electrocoagulation System”, by Volkel et al.; U.S. Pat. No. 8,518,235, entitled, “All-Electric Coagulant Generation System”, by Volkel et al.; U.S. Pat. No. 8,268,169, entitled, “Membrane Bioreactor (MBR) And Moving Bed Bioreactor (MBBR) Configurations For Wastewater Treatment”, by Meng H. Lean et al.; U.S. Patent Application Publication No. 2012/0152855, entitled “System and Apparatus for Seawater Organics Removal”, by Lean et al.; U.S. Patent Publication No. 2014/0197113-A1, entitled “Systems And Apparatus For Removal Of Harmful Algae Blooms (HAB) And Transparent Exopolymer Particles (TEP)” by Volkel et al.; U.S. Patent Publication No. 2014/0367348-A1, entitled “HDS Channel Exit Designs for Improved Separation Efficiency”, by Volkel et al.; and U.S. Patent Publication No. 2015/0175454 A1, titled “Recycling Activated Sludge by Hydrodynamic Separator (HDS) to Enable High MLSS Bioreactor to Process High Influent Flow and/or High Strength Wastewater.”

### BRIEF DESCRIPTION

A method of processing wastewater through a wastewater treatment plant includes providing wastewater to an aeration basin configured to receive the wastewater. Then suspended-growth biomass is produced, including at least one of activated sludge and mixed liquor suspended solids (MLSS) that is enriched for and collected within the aeration basin and a clarifier system and is used to degrade constituents in the wastewater. Portions of the activated sludge and/or MLSS are passed from the aeration basin over a weir to provide an aeration basin effluent channel positioned in operational association with the weir. The activated sludge and/or MLSS is received from the aeration basin effluent channel into inputs of a hydrodynamic separator (HDS) arrangement which is in operative connection with the aeration basin effluent channel. The HDS arrangement includes a plurality of individual curved channels, formed in a stack operative to generate flow fields comprising first portions and second portions of the activated sludge and/or MLSS. The activated sludge and/or MLSS is output from the HDS arrangement via HDS output openings, and the activated sludge and/or MLSS is split at the HDS output openings by a splitter plate positioned at or within the output openings of the HDS. The splitter plate directs the activated sludge and/or MLSS with the first portion flowing to a concentrate channel and the second portion flowing to an effluent channel. The activated sludge and/or MLSS in the concentrate channel is cycled back to the aeration basin or an aeration influent channel, and the activated sludge and/or MLSS of the effluent channel is passed forward for further clarification operations.

In another embodiment, a wastewater treatment plant incorporates a particle separation device. The plant includes an aeration basin having an input configured to receive wastewater. A weir directs the MLSS and/or activated sludge from the aeration basin to an aeration basin effluent channel positioned in approximate association to the weir to receive at least one of activated sludge and MLSS coming over the weir from the aeration basin. A hydrodynamic separator (HDS) arrangement includes a plurality of curved channels having inputs configured to receive the activated sludge and/or MLSS from the aeration basin effluent channel output and a plurality of outputs. The HDS arrangement is formed as a stack of individual channels operative to generate flow fields comprising first portions and second portions, the first and second portions of the flow field being formed by flow drive forces generated by the flow field in the curved channels. The flow driven forces includes centrifugal forces and at least low pressure forces or buoyancy forces; and a splitter mechanism positioned at or within the output openings of the HDS arrangement for directing a split of the activated sludge and/or MLSS such that the first portion flows on a first path and the second portion flows on a second path.

In another embodiment, a method is provided for processing wastewater through a wastewater treatment plant. Wastewater is provided to an aeration basin configured to receive the wastewater. Suspended-growth biomass is produced, including at least one of activated sludge and mixed liquor suspended solids (MLSS) that is enriched for and collected within the aeration basin and a clarifier system, and used to degrade constituents in the wastewater. Portions of at least one of the activated sludge and MLSS is passed from the aeration basin over a weir to an aeration basin effluent channel positioned in operational association with the weir, and configured to receive the activated sludge and/or MLSS coming over the weir from the aeration basin. The activated sludge and/or MLSS is received from the aeration basin effluent channel into inputs of a hydrodynamic separator (HDS) arrangement in operative connection with the aeration basin effluent channel. The HDS arrangement includes a plurality of individual curved channels, formed as a stack of the individual curved channels and operative to generate flow fields comprising first portions and second portions of the activated sludge and/or MLSS. The first and second portions of the activated sludge and/or MLSS flow being formed by flow drive forces generated by flow fields in the curved channels. The flow driven forces including centrifugal forces and at least low pressure forces or buoyancy forces. The activated sludge and/or MLSS being passed through the curved channels of the HDS arrangement by at least one of gravitational forces and hydrostatic pressure of the aeration basin effluent channel, and the inputs of the HDS arrangement. The activated sludge and/or MLSS from the HDS arrangement is output via HDS output openings. The activated sludge and/or MLSS at the HDS output openings is split by a splitter mechanism positioned at or within the output openings of the HDS arrangement for directing a split of the activated sludge and/or MLSS. The first portion flowing to a concentrate channel on a first path and the second portion flowing to an effluent channel on a second path. The activated sludge and/or MLSS in the concentrate channel is cycled back to the aeration basin or an aeration influent channel, and the activated sludge and/or MLSS of the effluent channel is passed forward for further clarification operations.

### BRIEF DESCRIPTION OF THE DRAWINGS

FIG. 1 is a typical hydraulic profile for an activated sludge plant;

FIG. 2 illustrates a more specific elevation view of a portion of a wastewater treatment including the water surface elevations in an aeration basin including a weir arrangement where water passes over the weir to an effluent channel;

FIG. 3 discloses a cross-sectional view of a portion of a waste water treatment plant arrangement that integrates the HDS into an aeration basin effluent channel;

FIG. 4 is a plan view showing the output channels of a HDS stacked channel arrangement and a removable, adjustable splitter plate to control flow and allow for cleaning;

FIG. 5 illustrates another view of a portion of a wastewater treatment plant that employs a HDS stacked channel arrangement;

FIG. 6 shows an alternative cross-sectional view of a portion of a waste water treatment plant according to the present application;

FIG. 7 illustrates an alternative view of the splitter of FIG. 6 ; and

FIG. 8 illustrates an alternative view of the splitter of FIG. 6.

FIG. 9A illustrates an elevation view of a wastewater treatment system incorporating an HDS arrangement according to the present application;

FIG. 9B illustrates a plan view of FIG. 9A;

FIG. 10 illustrates a clarifier distribution box in relation to a number of aeration basins and clarifiers;

FIG. 11A illustrates a more detailed view of a clarifier;

FIG. 11B illustrates a more detailed view of a distribution box;

FIG. 12 illustrates a cross-sectional view of an alternative implementation of the wastewater treatment system according to the present application wherein the HDS system is inverted in relationship to the system of FIG. 3;

FIG. 13 is a plan view showing the removable adjustable splitter plate to control flow and allow for reducing clogging in the channels;

FIG. 14 illustrates an alternative view of an inverted HDS stacked channel arrangement according to the present application.

FIG. 15 illustrates five (5) small channel stacks combined into a larger stack including a common manifold for the complete stack;

FIG. 16 is a closer view of the arrangement of FIG. 15;

FIG. 17 illustrates an alternative view of the splitter plate;

FIGS. 18A-18B depicts HDS channel arrangements in accordance with the present application;

FIG. 19 depicts two (2) channels of a HDS stacked channel arrangement and output channels for clean or clear and concentrated fluid flows having water level sensors;

FIG. 20 is an example feedback and/or control system illustrated for use in the wastewater treatment arrangement of the present application.

### DETAILED DESCRIPTION

Presented is a concept for integrating a hydrodynamic separator (HDS) stacked channel arrangement into aeration basin effluent channels to allow for solids separation to lower activated sludge and/or MLSS concentrations (HDS effluent) sent to secondary clarifiers or MBRs ideally via gravity, but possibly via pumping. Based on the large particle sizes of the activated sludge and/or MLSS flocs, low pressure HDS channels are used, which can be operated solely on hydrostatic pressure differences within the system. The HDS/effluent channel design has a flow-splitter device which allows for rapid cleaning as well as adjustable flow and solids distribution. Flow from the HDS system that has the higher concentration of activated sludge and/or MLSS (HDS concentrate) is returned to the head of the aeration basin via pumping. Optimal performance of the HDS channels is controlled through the water levels in input and output chambers.

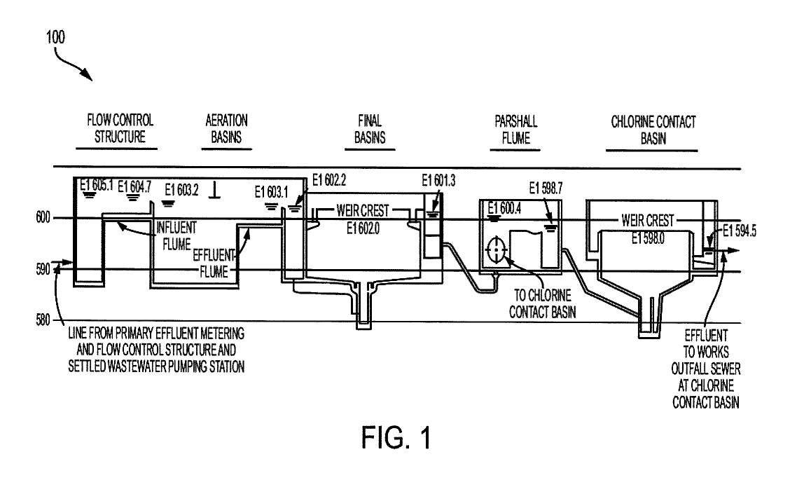

FIG. 1 illustrates an exemplary typical hydraulic profile 100 for a wastewater treatment plant such as an activated sludge plant, where water surface elevations are shown in feet above sea level for a plant representing flow of 160,000 cubic meters per day (m³/d) (42 million gallons per day (mgd)).

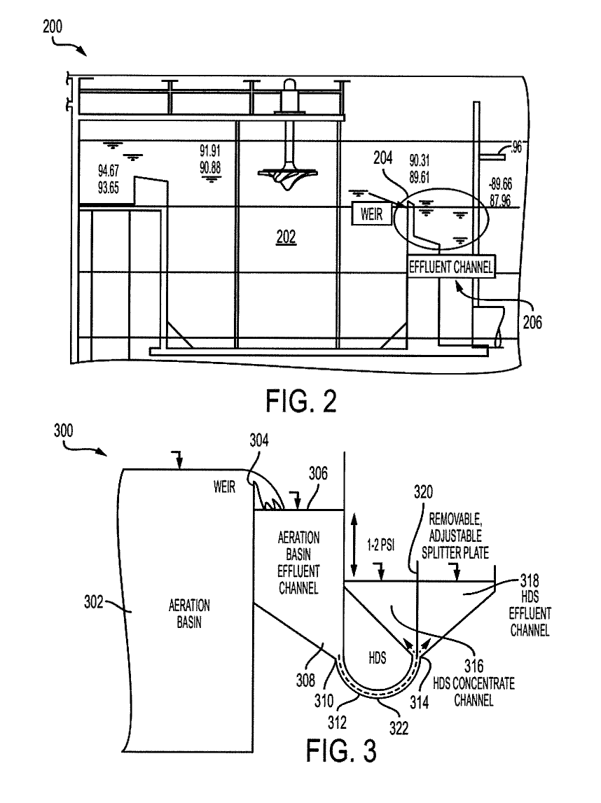

FIG. 2 is a hydraulic profile 200 for a particular portion of a wastewater treatment plant (slightly different from the one of FIG. 1) showing aeration basin 202 and weir 204 over which wastewater flows into an aeration basin effluent channel 206.

In the present disclosure inlets to the hydrodynamic separator (HDS) stacked channel arrangements or units are located at or near the bottom of aeration basin effluent channels such as shown in FIG. 2, whereby activated sludge and/or MLSS flows into and through the HDS stacked channels. Integrating HDS stacked channels at this location improves the removal and/or separation of activated sludge and/or MLSS, effectively acting as a pre-treatment device. The HDS effluent is then further processed and the HDS concentrate portion is recirculated. The integration of the HDS stacked channel arrangements of the disclosed embodiments enables (a) changes in the downstream system and processes including a smaller physical footprint of a wastewater treatment plant, by allowing for the use of smaller and/or fewer clarifier basins, MBRs, and chemicals then would otherwise be required; (b) a greater throughput capacity (treatment capacity, solids flux, hydraulic loading) of the downstream system and processes; or (c) some combination thereof.

One embodiment of the present application is illustrated by cross-sectional view of 300 of FIG. 3. Activated sludge and/or MLSS in aeration basin 302 flows over weir 304 into aeration basin effluent channel 306. A lower portion of channel 306 includes an output or openings 308 operationally associated or connected to input channel openings (HDS inlets) 310 of an HDS stacked channel arrangement 312, which also includes output openings (HDS exits) 314. These output openings 314 are operationally associated or connected to distinct separate channels: HDS concentrate channel 316 and HDS clean channel 318. At the output openings 314 of the HDS stacked channel arrangement 312, a splitter plate (or splitter) 320 is provided. Activated sludge and/or MLSS which flows to the left side of the splitter 320, of higher concentration, the HDS concentrate, is moved into the HDS concentrate channel 316, and activated sludge and/or MLSS which flows to the right side of splitter plate 320, of lower concentration, the HDS effluent, is moved into the HDS effluent channel 318. In some embodiments a pumping mechanism may be employed to return the HDS concentrate from the HDS concentrate channel 316 back to the aeration basin 302 via a return line (pipe) (not shown).

It is noted that in FIG. 3 the HDS arrangement 312 is positioned external to the concentrate channel 316 and the effluent channel 318, with the input openings 310 and output openings 314 positioned above the curved portion 322 of the HDS arrangement 312.

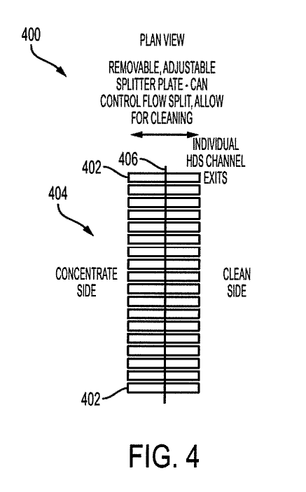

Turning to FIG. 4, shown is a plan view 400 of output openings 402 of a stack of HDS channels 404 and splitter 406 (i.e. corresponding to HDS stacked channel arrangement 312, output openings 314 and splitter 320 of FIG. 3). As can be seen in the view of FIG. 4 output openings 402 have no internal or integrated splitter (i.e., the openings are not bifurcated). Rather, splitter 406 (320) is used to direct the water into the appropriate channel. It is noted splitter 406 in one embodiment is a removable, adjustable plate, which controls the flow split and allows for easy cleaning to reduce the possibility of clogging. In certain embodiments the splitter 406 (320) is in the form of a thin (approximately 1/16 inches thick) sheet of stainless steel or other appropriate material. The splitter 406 (320 of FIG. 3) is in certain embodiments coated with a hydrophobic material to decrease material clinging to the splitter plate and thereby reducing clogging. In certain embodiments the splitter plate tip is pointed, wedge-shaped, sharpened, or sharpened with concave edges intending to improve hydraulic conditions to maximize solids separation.

The movable nature of splitter 406 (320) also allows for control of the flow entering the distinct separate channels 316, 318 (FIG. 3). For example, while the position shown in FIG. 4 is substantially in the middle of the output openings 402 (314 of FIG. 3) the splitter 406 may be re-positioned to the left or right to alter the flow into the separate channels 316 and 318.

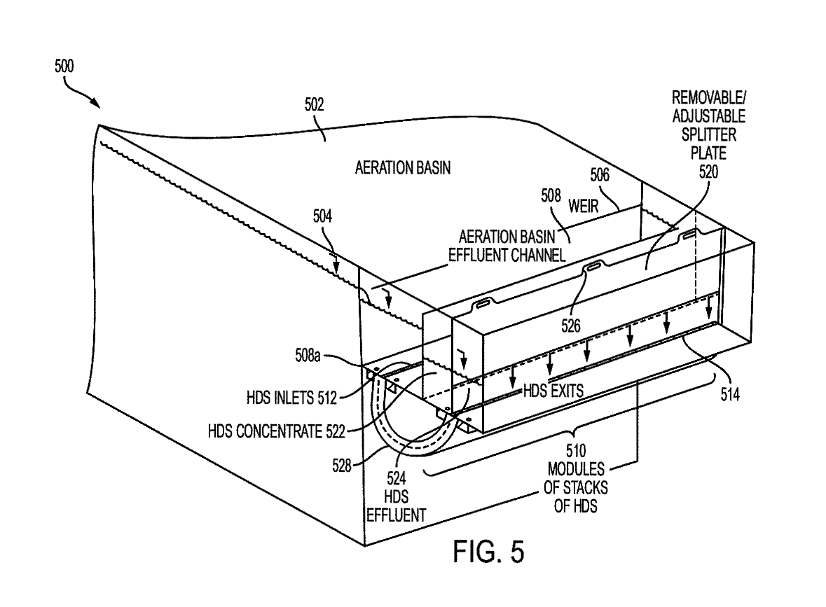

Turning to FIG. 5 illustrated is an alternative view 500 to the embodiment shown for example in FIG. 3. View 500 includes aeration basin 502 to which activated sludge and/or MLSS is provided. The upper surface of the activated sludge and/or MLSS being identified by the bent arrow 504. It is mentioned this bent arrow identifier is used throughout the drawings to define a wastewater level.

The activated sludge and/or MLSS flows over weir 506, which in certain embodiments is a metal or other rigid structure. In this embodiment the weir is a piece of sheet metal. However, weirs are configured in other forms and materials, and these are to be understood to be included in these concepts. The activated sludge and/or MLSS flows over weir 506 into aeration basin effluent channel 508. A bottom surface 508a of the aeration basin effluent channel 508 in operative connection to a HDS stacked channel arrangement 510. The HDS channels are formed as substantially half- to quarter-turn channels, where HDS inlets or input openings 512 are positioned to move the activated sludge and/or MLSS into the HDS arrangement 510. This configuration uses gravitational forces and hydrostatic pressure to move the activated sludge and/or MLSS into and through the channels to the HDS arrangement exits or output openings 514. The operation of the HDS stacked channel arrangement 510 separates the activated sludge and/or MLSS into two streams, including a less concentrated activated sludge and/or MLSS portion (HDS effluent) and a more concentrated activated sludge and/or MLSS portion (HDS concentrate). In this particular embodiment, at the HDS exits or output openings 514, a splitter plate 520 is provided, to control the output flow of the activated sludge and/or MLSS to either a HDS concentrate channel 522 or an HDS effluent channel 524. As can be seen, the splitter plate 520 operationally extends the length of the HDS stacked channel arrangement (i.e., modules or stacks of HDS channels) 510 to insure that the two streams from the HDS exits do not co-mingle. The splitter plate 520 is shown in a retracted position in FIG. 5, is also shown to include handles 526. These handles allow an operator to manually move the splitter plate 520 for cleaning. The handles also allow the operator to adjust the positioning of the splitter plate 520 over the exits or output openings 514 of the HDS arrangement 510. This positioning of the splitter plate 520 alters the amount of activated sludge and/or MLSS flowing into the HDS concentrate channel 522 and the HDS effluent channel 524. While not shown in this drawing (but shown in other drawings), the activated sludge and/or MLSS in the HDS concentrate channel 522 is re-cycled back to the aeration basin 502 for re-processing. The activated sludge and/or MLSS in the HDS effluent channel 524 is flowed forward for additional processing in the wastewater treatment plant such as to clarifiers or other components for continued solids separation.

It is noted that in FIG. 5 the HDS arrangement 510 is positioned external to the concentrate channel 522 and the effluent channel 524, with the input openings 512 and output openings 514 positioned above the curved portion 528 of the HDS arrangement 510.

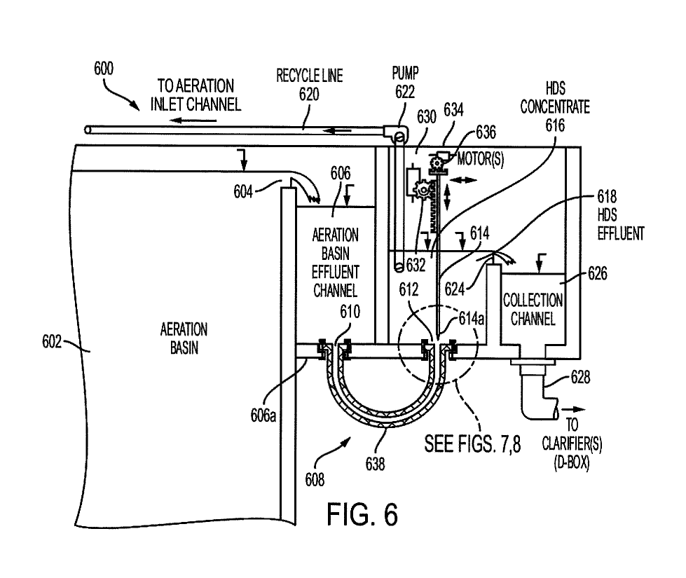

FIG. 6 illustrates a further cross sectional view 600 of a portion of a treatment plant incorporating the concepts of the present application. An aeration basin 602 again contains activated sludge and/or MLSS which flows over a weir 604 into the aeration basin effluent channel 606. Attached at a bottom surface 606a of the aeration basin effluent channel 606 is a HDS stacked channel arrangement 608. As seen here, activated sludge and/or MLSS in the aeration basin effluent channel 606 flows down into the input openings 610 of the HDS stacked channel arrangement 608, where gravitational forces and hydrostatic pressure pushes the activated sludge and/or MLSS through the curved (half- or quarter-turn, approximately 180° or less) channels, separating activated sludge and/or MLSS into a less concentrated activated sludge and/or MSS stream (HDS effluent) and a more concentrated activated sludge and/or MLSS stream (HDS concentrate), forcing the activated sludge and/or MLSS to flow out of exit or output openings 612. To guide the separated activated sludge and/or MLSS streams (i.e., so they do not intermix), provided is a splitter 614 with a tip end 614a at or near the base of the output openings 612. The splitter 614 and tip end 614a extend the length of the HDS stacked channel arrangement 608. activated sludge and/or MLSS on the left side of the splitter 614 is moved into the HDS concentrate channel 616, and activated sludge and/or MLSS impinging on the right-hand side of the splitter 614 flows into the HDS effluent channel 618.

In this embodiment, activated sludge and/or MLSS in the HDS concentrate channel 616 is moved through recycle line 620 which flows the concentrated activated sludge and/or MLSS back to the inlet of aeration basin 602 for further processing. In the present embodiment, a pump 622 is optionally shown to assist in moving the concentrated activated sludge and/or MLSS from the HDS concentrate channel 616 to the inlet of aeration basin 602.

With regard to the dilute activated sludge and/or MLSS in the HDS effluent channel 614, as the liquid level increases, it spills over weir 624 into a collection channel 626, which includes a lower output 628, providing the HDS effluent to clarifiers (i.e., either directly or through a distribution box, as is known in the art).

It is shown in this embodiment, that the splitter 614 is a movable as well as removable component. More particularly, provided is a motor 630, which operates with a vertical geared mechanism 632, and a motor 634 which operates with a horizontal geared mechanism 636. These arrangements are in operative connection with splitter 614 to move the splitter in vertical and horizontal directions. For example, splitter 614 is movable-vertically into close relationship with the HDS channel openings 612. In some instances, the splitter may be placed immediately outside of the openings 612, whereas in alternative embodiments, dependent on particular implementations, the splitter 614 may be moved (inserted) within the opening (provided the HDS channel exits are notched to accommodate the splitter) such that the splitting of the wastewater is occurring prior to fully exiting the HDS opening 612. Additionally, the splitter 614 may be moved horizontally in the left and right directions whereby the amount of wastewater entering the HDS concentrate channel 616 and the HDS effluent channel 618 is controlled.

It is mentioned, the movement of the splitter in the left or right directions is altered dependent on process control objectives. When there is a lower concentration of activated sludge and/or MLSS in the aeration basin effluent channel, it may be desirable to move the splitter 614 to the left, whereby more of the dilute activated sludge and/or MLSS is provided to the HDS effluent channel 618. Whereas, when there is a high concentration of activated sludge and/or MLSS in the aeration basin effluent channel, the splitter 614 could be moved to the right, whereby less of the dilute activated sludge and/or MLSS is flowed into HDS effluent channel 618, and more of the concentrated activated sludge and/or MLSS is being recycled back through the system for further processing via the HDS concentrate channel 616. Having the ability to adjust the flow split and hence affect the distribution of solids in the system allows the operator to have greater control of both the inventory of activated sludge and/or MLSS solids in the aeration system and also the performance of the solids separation units (e.g., clarifiers) downstream of the aeration basins.

It is noted that in FIG. 6 the HDS arrangement 608 is positioned external to the concentrate channel 616 and the effluent channel 618, with the input openings 610 and output openings 612 positioned above the curved portion 638 of the HDS arrangement 312

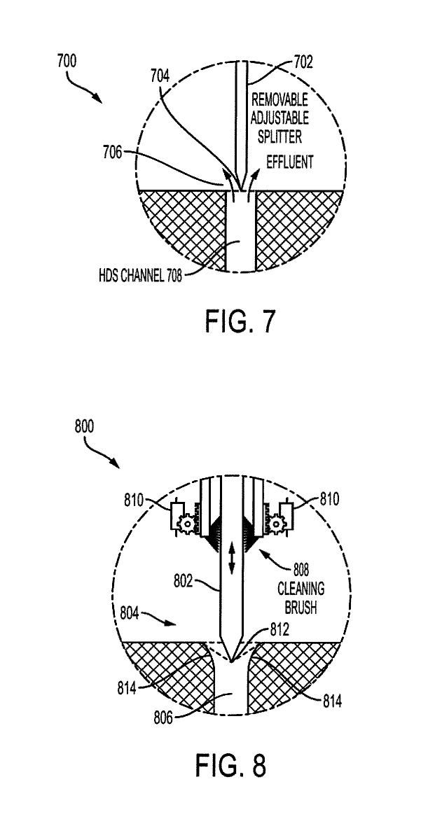

FIG. 7 is a more detailed view of the area of interaction between the splitter and the HDS channel showing the point or tip end of the splitter. View 700 illustrates a side view of the removable adjustable splitter 702 (614 of FIG. 6), positioned in a manner discussed in connection with FIG. 6. Particularly, a tip end 704 of splitter 702 is placed immediately outside an opening 706 of a HDS channel 708. This arrangement means there is no need of an internal bifurcation within the channel (i.e., built in during a molding process, for example), rather the channel 708 itself is uninhibited with such potential clogging areas. It is known that clogging can occur in an internally bifurcated channel and that clogging in such configurations is difficult to resolve. However, by having a removable adjustable splitter 702 immediately at the face of the output 706, flow is directed in appropriate directions, and the splitter, should there be a clogging issue, may be removed and cleaned, and/or replaced.

View 800 of FIG. 8 illustrates a similar side view of a removable adjustable splitter 802 associated with a channel output opening 804 of a channel 806, which has been previously discussed. However in this embodiment, provided is an automated cleaning brush mechanism 808. If debris begins to be found on splitter 802 (or at some scheduled time or at an operators discretion) while the splitter 802 is within an operational distance to the output opening 804 of the HDS channel 806, the cleaning brush mechanism 808 is moved in order to clean splitter 802 while the splitter remains in place (in situ). Alternately, the splitter tip 802 can be extracted and replaced, drawing the splitter through a stationary cleaning brush mechanism 808. In one embodiment a motor based movement system 810 is provided to automatically move the cleaning brush mechanism 808 or alternately the splitter tip 802 in an appropriate manner.

Also shown in FIG. 8 is that a tip end 812 of the splitter 802 is within opening 804 of channel 806. This arrangement is intended to provide a smoother transition of the activated sludge and/or MLSS flow, as splitting is occurring within the walls of the channel 806 controlling turbulence that might otherwise occur. For this arrangement, in order for the splitter tip end 812 to be within output opening 804, the output opening 804 is widened. As can be seen in FIG. 8 the opening 804 includes outwardly curved walls 914 to allow for insertion of the tip end 912 of splitter 802 while allowing sufficient area for activated sludge and/or MLSS to pass to the appropriate channels (e.g., 614, 616 of FIG. 6). It is to be appreciated that each of the openings in the HDS stack have their edges widened to allow the edge of the splitter extending over these openings to also be within the opening.

In an alternative embodiment, each of the output openings include a slit that matches the profile of the tip end 812, to allow the tip end 812 to be placed within the output openings, and accommodates any movement of the splitter across the exits that is intended to alter the flow split.

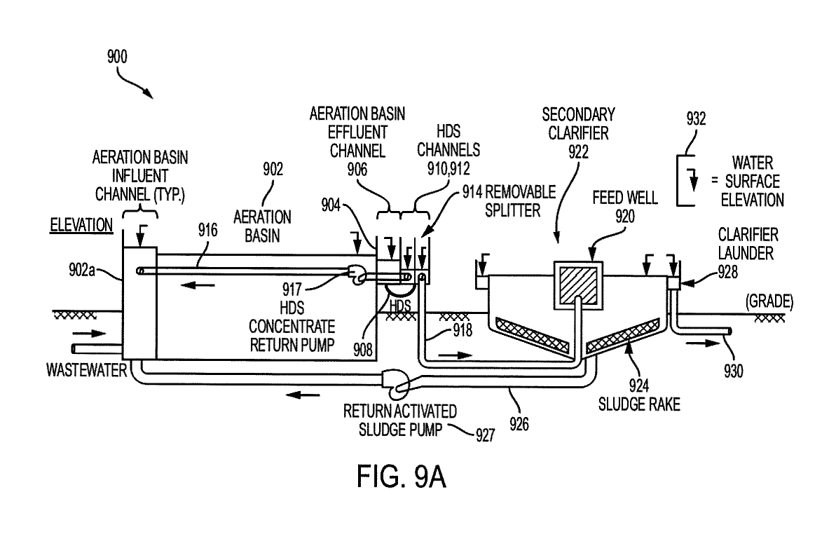

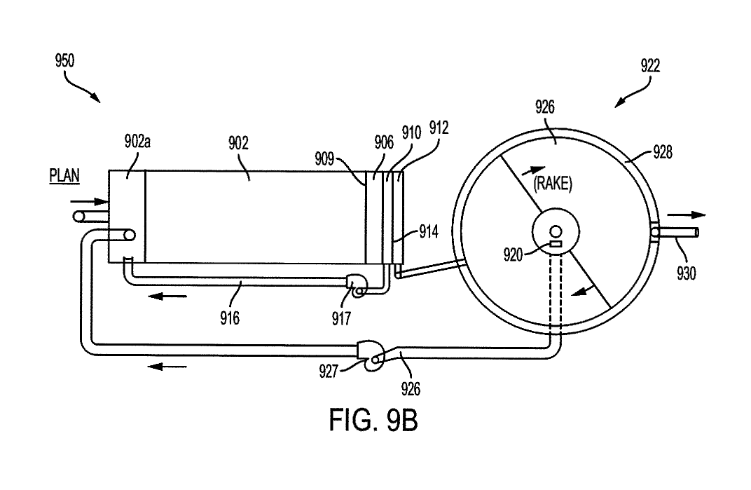

Turning to FIG. 9A and FIG. 9B, illustrated are an elevation view 900 and plan view 950 for a wastewater treatment system implementing a HDS stacked channel arrangement such as shown the previous figures.

FIGS. 9A and 9B illustrate the elevation and plan views mentioned above for an HDS system within a half-turn (or less degree of curvature) HDS stacked channels. This view includes additional portions of a wastewater treatment plant. More particularly, in addition to aeration basin 902, similar to previous discussions, weir 904 is positioned whereby activated sludge and/or MLSS from the basin 902 flows over and into the aeration basin effluent channel 906. Then as previously mentioned, activated sludge and/or MLSS flows through the HDS stacked channel arrangement 908, and is sent to either the HDS concentrate channel 910 or the HDS effluent channel 912, via the use of a splitter 914. In a similar manner as described previously, a recycle line 916 and pump 917 will move wastewater from the HDS concentrate channel 910 back to an aeration influent channel 902a of aeration basin 902.

Activated sludge and/or MLSS from the HDS effluent channel 912 is flowed by line 918 to a clarifier feed well 920 located inside secondary clarifier 922. The secondary clarifier 922 includes a sludge rake 924 which moves settled, thickened sludge out of the secondary clarifier 922 into activated sludge pump return line 926 and the pump 927, back into the beginning of aeration basin 902. With continuing attention to FIGS. 9A and 9B, clarifier launder 928 (shown best in FIG. 9B) moves clarified effluent out of the clarifier 922 via pipe 930 for further processing (e.g., disinfection) and ultimate discharge.

As noted previously, various drawings used herein are side or cross-sectional views looking “into the paper”. It is to be understood the described treatment plants (or portions thereof) commonly include multiple repetitions of the components that have been discussed, as well as others (e.g., multiple aeration basins, weirs, aeration basin effluent channels, HDS stacked channel arrangements, etc.). These parallel process units are often called trains.

When there are multiple trains with more than one clarifier, flow is often first routed through a clarifier distribution box. The distribution box may be outfit with adjustable weirs and gates which allows for distribution of activated sludge and/or MLSS to clarifiers. As an overall intent is for wastewater treatment plants to flow by gravity, using as little pumping as possible, having adjustable weirs allows for final flow control tweaking (e.g., in case a wall is too high, settles after construction, is not level, etc.). Further the gates allow operators to shut flow to one or more clarifiers to take them out of service for maintenance.

The right angled arrows, e.g. 932 (numbered once) although there are numerous other arrows is intended to show the water surface elevation at specific locations.

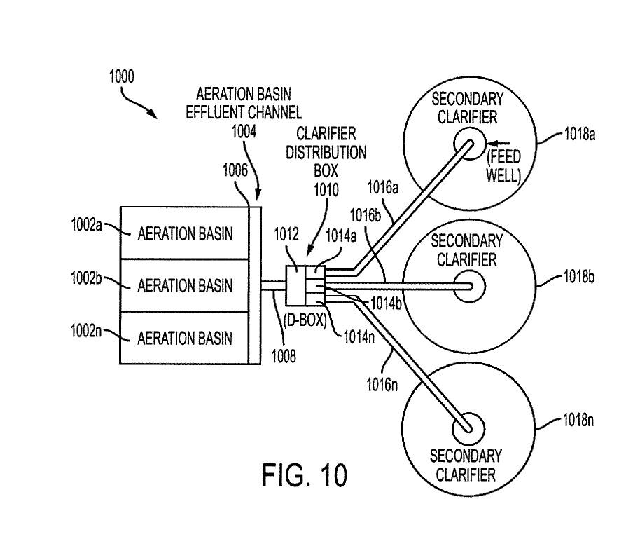

As mentioned above, while a number of the drawings illustrate views that appear to show a single aeration basin and/or possibly single clarifier; in wastewater treatment plants there are commonly multiple ones of these and other components. In these plants, it is common to use the previously discussed distribution box (D-Box). FIG. 10 depicts a simplified version of a water treatment plant 1000, more particularly showing portions of that plant to emphasize the multiple implementations of the various components. More particularly, aeration basins 1002a, 1002b . . . 1002n are intended to illustrate the concept of multiple aeration basins which provide their content to an aeration basin effluent channel 1004 after flowing over a weir 1006. Fluid flow (e.g., activated sludge and/or MLSS) from the aeration basin effluent channel 1004 moves through a transport arrangement 1008 (e.g., pipe or channel) to the clarification distribution box (D-Box) 1010. It is noted the transport arrangement 1008 may in certain embodiments be the HDS arrangements such as discussed in previous figures (e.g., FIGS. 3, 5, 6, 10, 9A, 9B, 12, 14, 15 and 16, among others). Clarification distribution box 1010 includes a front portion 1012, which receives the fluid flow, and then distributes this fluid flow into distinctly defined upstream fluid containment areas 1014a, 1014b . . . 1014n, which in turn provide the fluid to dedicated lines 1016a, 1016b . . . 1016n. These lines supply secondary clarifiers 1018a, 1018b . . . 1018n. Again, the number of clarifiers and associated equipment are intended to show that there are multiple arrangements of these components within a water treatment plant.

Turning to 11A, illustrated is a cutaway drawing of a typical secondary clarifier arrangement 1100 (http://www.mon-env.com/water-and-wastewater-treatment/circular-clarifiers/circular-clarifiers-secondary), emphasizing complexity beyond that of a simple holding tank. Particularly provided is an influent area 1102 for receiving the fluid flow (e.g., activated sludge and/or MLSS), as well as a sludge discharge area 1104 near the bottom of the clarifier 1100. An assembly also operating near the bottom surface of the clarifier includes a riser pipe 1106, a rake arm 1108 and a scraper blade 1110. Along the outer perimeter of the clarifier 1100 is an effluent launder 1112, a v-notched weir 1114, scum baffle 1116, as well as an effluent trough 1118 and a scum trough 1120. Operating in conjunction with the elements at the outer surface of the clarifier is a skimmer arm 1122. In the center shaft area of the clarifier 1100 is a sludge box 1124 and feedwell 1126, along with a drive motor 1128 used to operate the various components. Also shown in this figure, which emphasizes the large size of clarifiers, is a gate walkway 1130 which a technician may use to gain access to the center of the clarifier 1100 even when it is filled with fluid. This allows the technician to possibly provide maintenance to the drive motor 1128 or perform other maintenance operations.

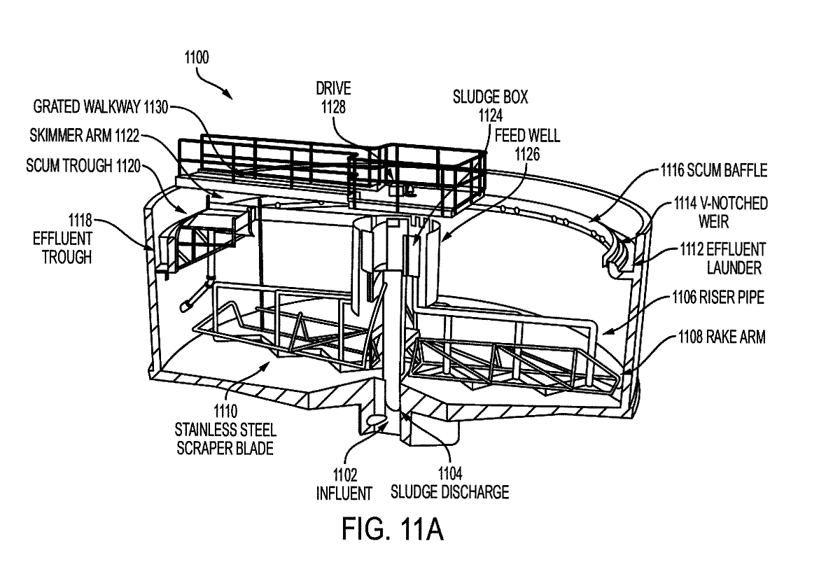

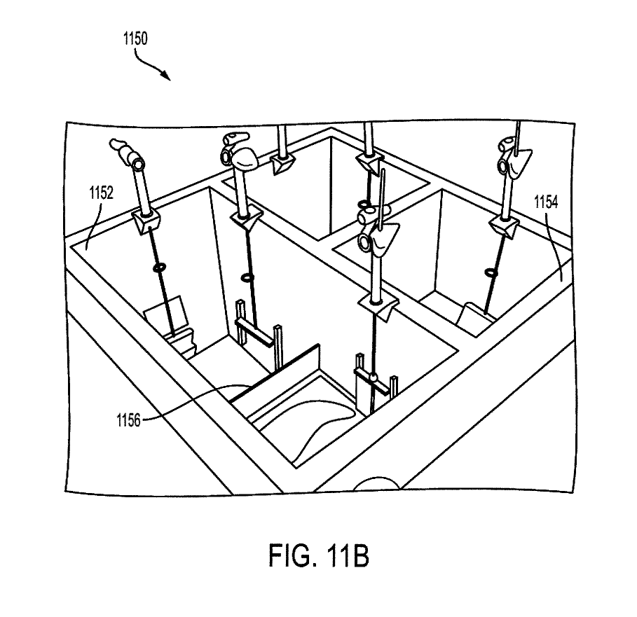

Turning to FIG. 11B, illustrated is a more detailed view of a clarifier distribution box 1150, where the main half or fluid receipt area 1152 is depicted as a large area capable of receiving input from a plurality of aeration basins and associated components. Individual upstream fluid containment areas 1154 are also shown. It is to be appreciated that the distribution box 1150 may be open to the atmosphere, and will include weirs 1156 and gates (not shown) for flow control.

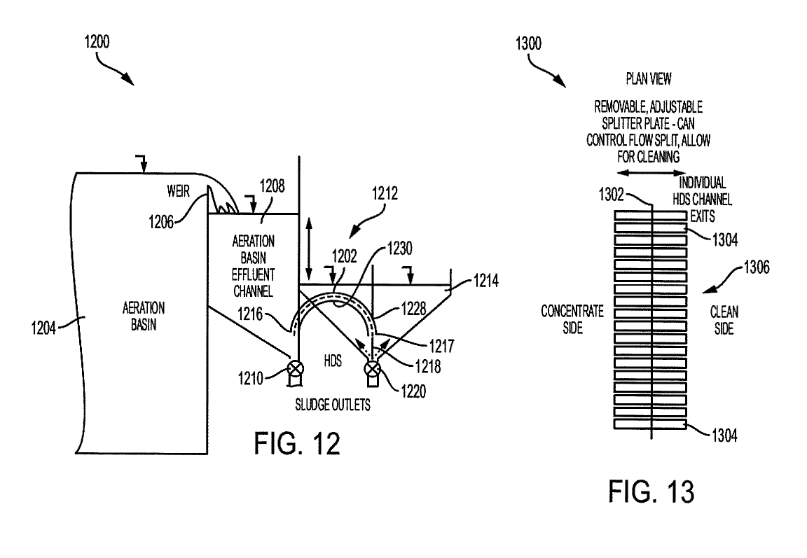

Turning to FIG. 12, illustrated is a cross-sectional view 1200 of a portion of a wastewater treatment plant incorporating a HDS stacked channel arrangement 1202. However in this embodiment, the HDS stacked channel arrangement 1202 is inverted (substantially 180 degrees) in comparison to the HDS channel stack arrangement 312 of FIG. 3.

Again, activated sludge and/or MLSS from aeration basin 1204 spills over a weir 1206 such that the activated sludge and/or MLSS flows to aeration basin effluent channel 1208. In this embodiment the HDS stacked channel arrangement 1202 is submerged within at least a HDS concentrate channel 1212 and/or a HDS effluent channel 1214. In this arrangement gravitational forces and hydrostatic pressure act to flow the activated sludge and/or MLSS to HDS input openings 1216 located at or near the bottom on aeration basin effluent channel 1208 and passes through the HDS stacked channel arrangement 1202 to the output openings 1217. The HDS concentrate stream is directed to the concentrate channel 1212, while the HDS effluent stream is directed to the HDS effluent channel 1214 by use of splitter 1218.

Thereafter, as previously discussed the activated sludge and/or MLSS from the HDS concentrate channel 1212 is moved back to the aeration basin for further processing, and the activated sludge and/or MLSS in the HDS effluent channel 1214 is moved through additional portions of the wastewater treatment plant for further processing.

In order to maintain separation of the activated sludge and/or MLSS in the concentrate channel 1212 and the effluent channel 1214, wall 1226 is provided and abuts 1228 an outer surface of the HDS stacked channels 1202. At this abutment location1228 a sealing material is used to avoid leakage of the activated sludge and/or MLSS between the two channels 1212, 1214. In some embodiments stacks of HDS channels 1202 and wall 1226 are formed as a single structure.

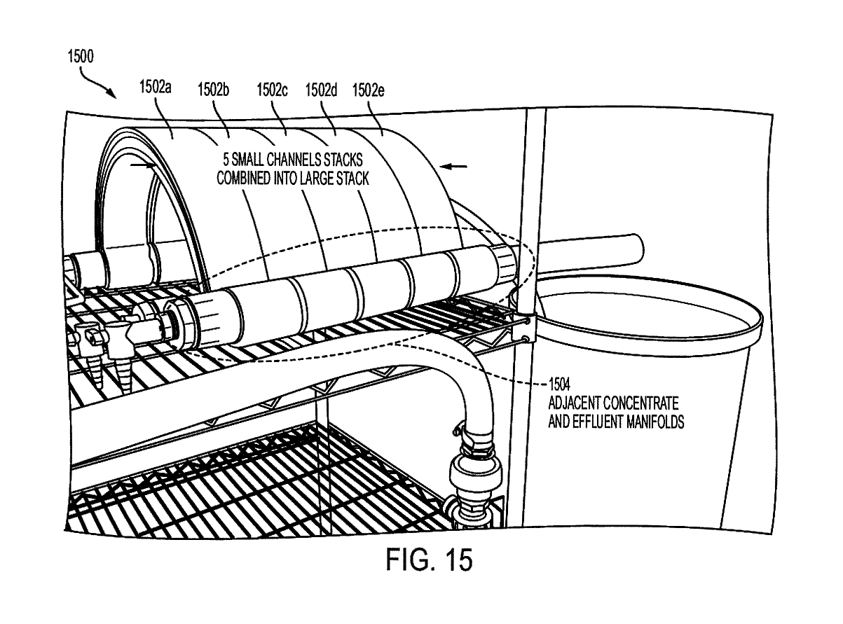

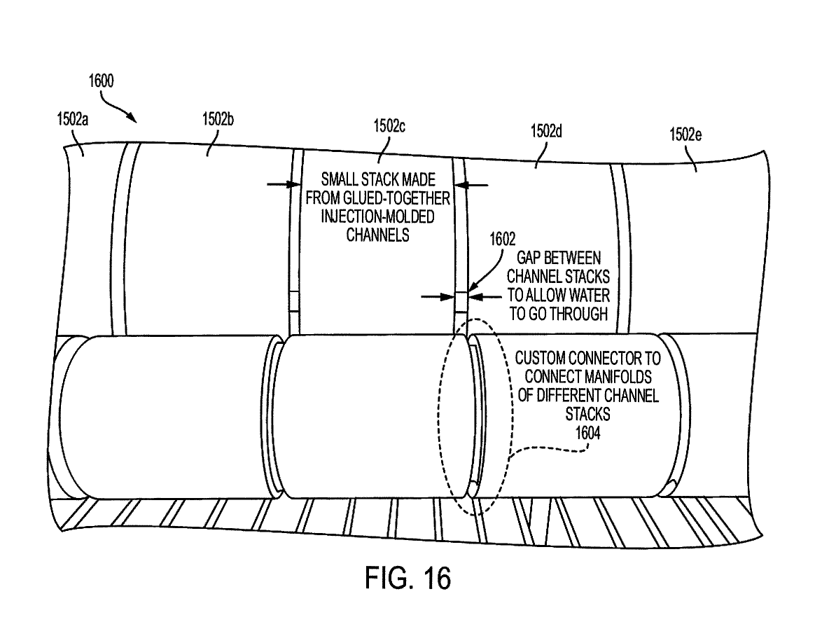

Also as the HDS channel stack 1202 is submerged in the channels 1212, 1214, gaps are provided between selected channels of the HDS stacked channel arrangement 1202 in the concentrate channel 1212 to allow the activated sludge and/or MLSS to flow, and the gaps are sealed (or not otherwise provided) for the portion of the submerged HDS stacked channel arrangement 1202 within the effluent channel 1214. By blocking the gaps in this way, intermixing of the separate wastewater streams is avoided. The gaps are explained and shown in more detail in FIGS. 15 and 16.

With continuing attention to FIG. 12 the items “x within a circle” 1210, 1220 were noted in certain embodiments to be closed off portions. However, in other embodiments they are valves that can be opened when sludge or other particulates are in the system and opening the valves will drain the sludge or other particulates out of the system.

It is noted that in FIG. 12 the HDS arrangement 1202 is positioned within (submerged) the concentrate channel 1212 and the effluent channel 1214, with the input openings 1216 and output openings 1217 positioned below the curved portion 1230 of the HDS arrangement 1202.

FIG. 13 is a plan view 1300 (similar to FIG. 4) which shows a splitter 1302 (1218 of FIG. 12). Similar to previous discussions, the splitter 1302 may be moved along the output openings 1304 of the HDS arrangement 1306, as well as being removable for cleaning. The operation of the splitter controls the fluid split into one of the two channels (see FIG. 12, channels 1212, 1214). In certain embodiments the splitter 1302 is in the form of a thin (approximately /16 inches thick) sheet of stainless steel or other appropriate material. The splitter 1302 is in certain embodiments coated with a hydrophobic material to decrease material clinging to the splitter plate and thereby reducing clogging. In certain embodiments the splitter plate tip is pointed, wedge-shaped, sharpened, or sharpened with concave edges intending to improve hydraulic conditions to maximize solids separation.

The movable nature of the splitter 1302 also allows for control of the flow entering the separate channels 1212, 1214 (e.g., FIG. 12). The splitter 1302 may be re-positioned to the left or right of the output opening 1304 to increase or decrease the flow into the separate channels 1212 and 1214.

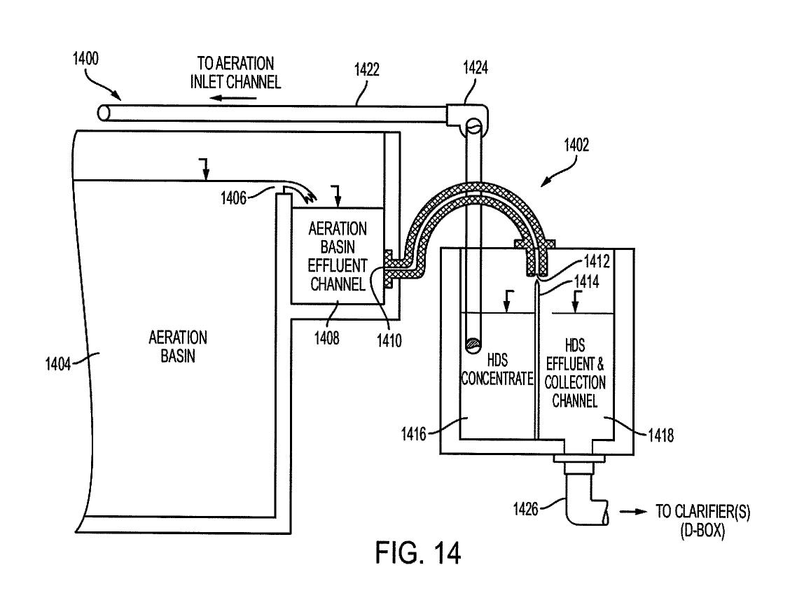

Turning to FIG. 14 illustrated is an alternative cross sectional view 1400 of an inverted HDS stacked channel arrangement according to the present application. While in FIG. 12, the HDS stacked channel arrangement 1202 is submerged within the activated sludge and/or MLSS, in present embodiment the HDS stacked channel arrangement 1402 is positioned external the various channels, as the arrangement for FIG. 6. Thus, activated sludge and/or MLSS from aeration basin 1404 flows over weir 1406, and into aeration basin effluent channel 1408. The inputs 1410 of HDS stacked channel arrangement 1402 are positioned near the bottom of a side wall of the aeration basin effluent channel 1408. The positioning of the HDS stacked channel arrangement 1402 in this way allows for the necessary gravitational forces and hydrostatic pressure to move the activated sludge and/or MLSS through the HDS stacked channel arrangement 1402. Also depicted in FIG. 14, outputs 1412 are not submerged, and the output flow is directed by a splitter 1414 to either the HDS concentrate channel 1416 and the HDS effluent and collection channel 1418 in a manner as previously discussed (e.g., re-cycle line 1422 and pump 1424). In some embodiments splitter 1414 includes motorized cleaning brushes (see FIG. 8) and is adjustable (see FIGS. 5, 6). Channel 1418, includes an output 1426 on its bottom surface which passes the effluent wastewater for further processing, such as by clarifiers (see FIGS. 10 and 11). For some embodiments with multiple trains, flow first pass through a distribution box prior to being sent to multiple clarifiers.

In the embodiment of FIG. 14, the HDS effluent channel and collection channel 1418 are combined into a single component. This is in distinction to FIG. 7 which employs separate components for these features.

It is noted that in FIG. 14 the HDS arrangement 1402 is positioned external to the concentrate channel 1416 and the effluent channel 1418, with the input openings 1410 and output openings 14212 positioned below the curved portion 1426 of the HDS arrangement 1402.

In each of the forgoing embodiments, the inputs to the HDS stacked channel arrangements make connection the aeration basin effluent channel at the bottom surface of the aeration basin effluent channel or in a sidewall substantially at or near the bottom, i.e., within the lower 10% or less portion of the side wall. A specific design location will depend on the available hydraulic head, the size and depth of the aeration basin effluent channel when present, the design and therefore the pressure requirements of the stack of HDS channels being used. In either case, the intent is to have the liquid level of the aeration basin effluent channel provide the driving head that forces activated sludge and/or MLSS through the stack of HDS channels. Too much or too little pressure (as hydraulic head) will prevent the stack of HDS channels from functioning well or at all, because the necessary flow rates and hydraulic conditions cannot be met or maintained. It is also noted that with regard to the embodiments of FIGS. 12 and 14, due to the arrangements illustrated, flow and/or particles are encouraged to move away from the exits or outputs (1217, 1412) by gravitational forces if relevant (e.g., if the fluid is discharging to a free surface, or if particles have a specific gravity greater than water). This reduces the chances of clogging of the outputs (1217, 1412). The.

FIG. 15 illustrates a HDS channel stack 1500 with fully enclosed inlet, concentrate, and effluent manifolds with immobile and integrated splitters. In FIG. 15, five (5) individual channel stacks 1502a-1502e are positioned together and operate off a common inlet manifold (not shown). Here, water comes from this manifold and is dispersed into each of the stacks that are combined into a larger stack (i.e. 1502a-1502e). The concentrate manifold and effluent manifold are located side-by-side (1504). FIG. 15 shows the effluent and concentrate being discharge to a common tank.

Turning to FIG. 16, view 1600 illustrates a section of the arrangement of FIG. 15. As depicted more clearly, the individual stacks 1502a-1502e may have hundreds of individual channels that are connected (e.g., glued or otherwise fastened) together to form an individual stack. Shown are small stacks of channels that are joined to form a large single stack that is hydraulically continuous. The channels may in one embodiment be formed by injection molded channels. Between each of the small stacks of channels are gaps 1602 in an otherwise solid structure. It is also understood the size and number of gaps is selectively chosen for particular implementations. Not every connection (e.g., glued connection) may have a gap, and in certain embodiments no gaps may be included. This allows, for example when used in an embodiment as illustrated in FIG. 12 (i.e., where the stacked channels are submerged within the activated sludge and/or MLSS), for the activated sludge and/or MLSS coming from the splitter 1216 to flow through the gaps and allow for the passage of the water in the channels 1212, 1214. The manifolds of different channel stacks are connected through a custom washer-like connector 1604.

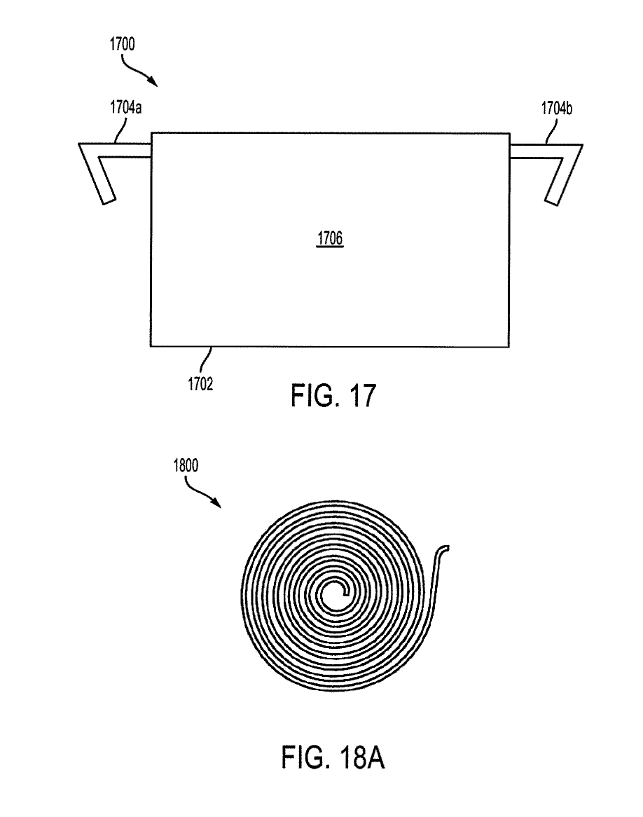

FIG. 17 illustrates an alternative configuration and view of a splitter plate 1700. In this embodiment splitter plate 1700 is in the form of a rectangular metal sheet where its lower end 1702 may be a straight edge or a tapered edge as has previously been discussed. Included in this embodiment are spring-type based connection arms 1704a, 1704b which are sized to clasp an outer surface of a HDS channel within a stack (module) of HDS channels. The use of the connection arms 1704a, 1704b assist in maintaining the plate portion 1706 in place.

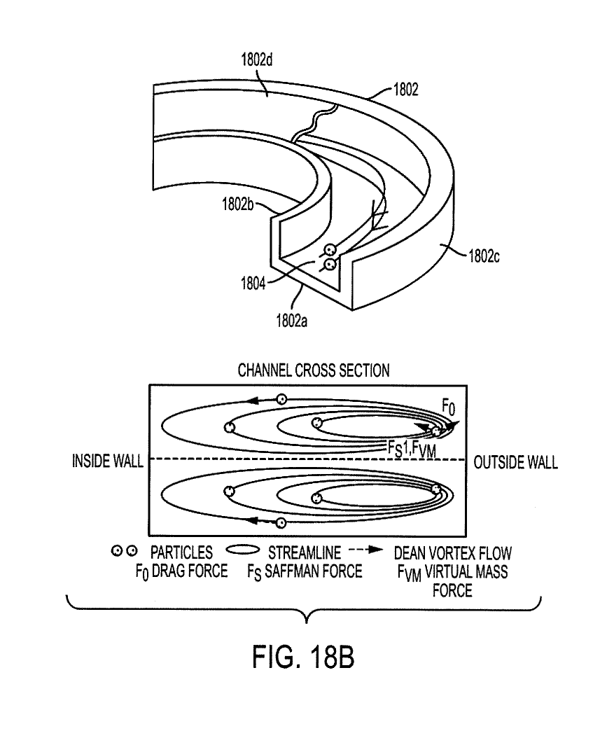

Turning to FIG. 18A, while the foregoing has focused on the use of HDS half turn channels (while called half turn the actual curve of the channel may be less than)180°, the present concepts may also employ channels with less or greater degrees of curvature. For example spiral based channels 1800 of FIG. 18A may be employed to carry out the present teachings. It is understood this is just one example, and the channels described within the documents incorporated by reference may also be used.

With attention to FIG. 18B, as described in various ones of the material incorporated by reference, HDS channels take advantage of centrifugal forces to separate particles based on size rather than density. The flow at the end can then be split to generate separate fluid flows which include a more concentrated fluid flow portion and a fluid flow portion. As shown by view 1802 of FIG. 18B, in addition to separating particles having a specific gravity greater than water (e.g., sand); HDS systems are further capable of the separation of substantially neutrally buoyant particles from a liquid (e.g., activated sludge and/or MLSS); HDS systems are further capable of the separation of particles having a specific gravity less than water (e.g., emulsions). Because of centrifugal forces on the liquid flowing through the channel, transverse flow patterns emerge. Under certain flow conditions and geometrical constraints these transverse flow patterns emerge as a pair of Dean Vortices. Particles entrained in such a flow are spiraling around these vortex cores as they move along the channel. In certain locations, lift-forces, due to the high shear gradients inside the channel push the particles closer to the vortex centers, causing a dynamic focusing of the particles into a band around the vortex cores.

FIG. 18B illustrates the curved channel 1802 which is to be found in such hydrodynamic separation units. The curved channel 1802 includes a bottom wall 1802a, an inner side wall 1802b, an outer side wall 1802c and a top wall 1802d.

With continuing attention to FIG. 18B, it is shown that centrifugal forces acting on the liquid stream introduce a transverse flow pattern, which can manifest as a pair of Dean Vortices. Under the right flow conditions a combination of hydrodynamic forces (drag, shear, inertia) move suspended particles to an equilibrium position near one of the side walls. This separation mechanism is to first order independent of the specific gravity of the particles, allowing the concentration of neutrally buoyant particles 1804 (e.g., particles having substantially the same specific gravity as water, or the fluid in which the particles reside) flowing in a fluid, e.g. water, to facilitate improved separation of such particles from the fluid into a concentrated mass. All the forces acting on the particles are dependent on the size of the particle, and only particles exceeding a certain cut-off size will be concentrated. The smaller a cut-off size is desired, the higher is the required pressure head. For example, a 360 degree turn hydrodynamic separator designed for a 20 micron particle size cut-off can be realized with less than 20 psi pressure head (standing head). If the suspended particles that need removal are very small, it is desirable to grow them into larger entities before attempting to employ hydrodynamic separation.

Depending on the channel geometry and the flow rate the particles are concentrated either at the inner or the outer side wall.

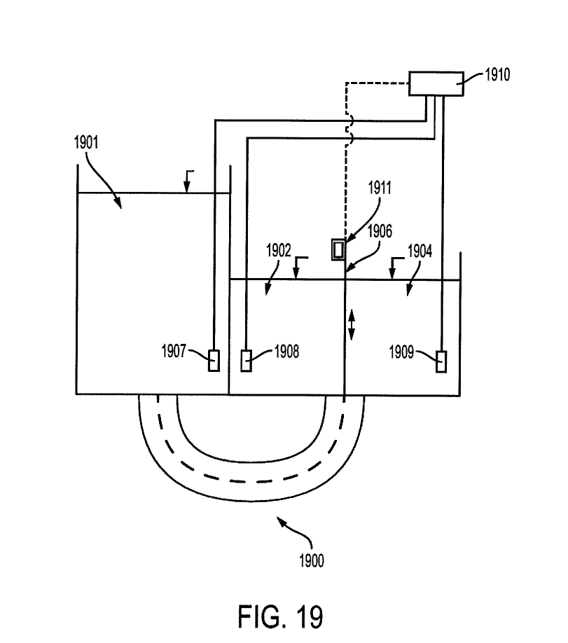

Turning to FIG. 19, illustrated is a sensor system employed in an HDS arrangement 1900. This embodiment shows aeration effluent channel 1901 and the HDS arrangement 1900 flowing into HDS concentrate channel 1902 and effluent channel 1904 separated by splitter plate 1906. Sensor 1907 is shown in the aeration effluent channel, sensor 1908 is shown in HDS concentrate channel, and sensor 1909 is shown in HDS effluent channel. Controller 1910 is shown receiving signals from sensors 1907, 1908 and 1909.

As it is undesirable for the HDS channels within the HDS arrangement to clog, sensing the water levels, the solids concentrations, the hydrostatic pressure, or the turbidity in the HDS concentrate and HDS effluent channels allows an indirect evaluation of whether the HDS channels within the HDS arrangement is clogged. For example, water (e.g., activated sludge and/or MLSS) rising above a pre-determined acceptable level in one channel compared to the other may be an indication of clogging. Changes in water level are also indicated by changes in hydrostatic pressure within the HDS concentrate and HDS effluent channels, and differences in hydrostatic pressure outside a pre-determined acceptable level in one channel compared to another may be an indication of clogging. Also for example, the solids concentration in one channel compared to the other being within certain proximity (i.e., if the concentrations are the same in both channels) may be an indication of clogging. Solids concentration is also indicated by turbidity within the HDS concentrate and HDS effluent channels, and differences in turbidity are within a certain proximity (i.e., if the turbidity readings are the same in both channels) may be an indication of clogging. In either situation, the output from the sensors 1907, 1908 and 1909 is provided to a controller 19110 specific to the parameter being monitored. The controller 1910 includes an alarm or some other notification that indicates to an operator that the limits are exceeding a predetermined set-point. This provides the operator with information that may indicate clogging is occurring and gives the operator with an opportunity to replace and/or clean the splitter 1906. The controller 1910 may actuate splitter motor 1911 to raise, lower, or otherwise initiate a cleaning sequence directly.

In FIG. 19 it is shown that the sensors 1907,1908 and 1909 are in wired communication. However in other embodiments the system may be a wireless communication network. Also the sensors may be any of a number of known sensor sensing configurations including but not limited to mechanical, electrical as well as laser based systems.

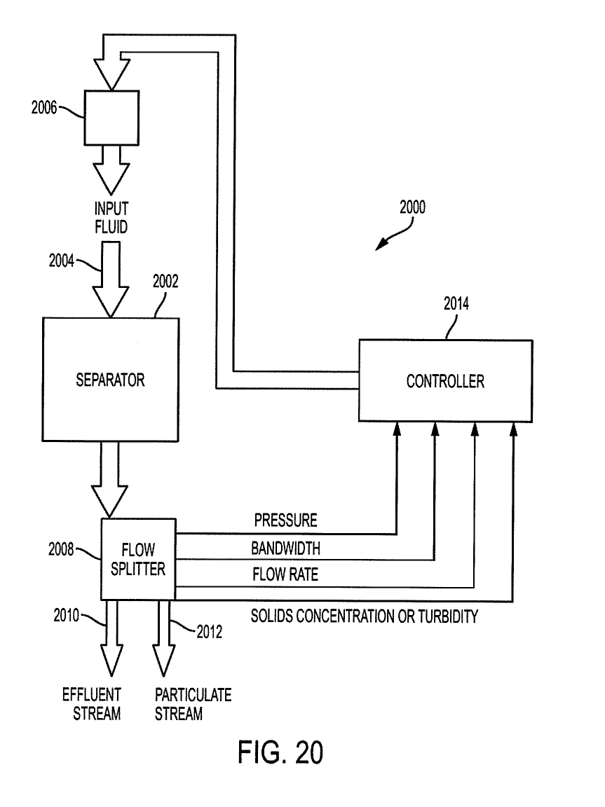

With reference to FIG. 20, an example feedback and/or control system 2000 is illustrated. System 2000 is intended to operate in water treatment arrangements that include a separator such as a HDS stacked channel arrangement 2002 (such as discussed in the foregoing embodiments) that receives input fluid 2004. The flow of the input fluid is controlled by an input controller 2006. In some embodiments the input controller is a fluid pump. In other embodiments, which employ gravity to have fluid enter the system, the input controller 2006 it may be a valve that controls the input fluid flow, or an adjustable weir that controls the liquid level. In operation, separator 2002 separates the input fluid 2004 and a splitter 2008 moves the fluid from the HDS stacked channel arrangement 2002 into an effluent channel 2010 and a concentrate channel 2012.

As previously discussed, a splitter 2008 is positioned to split activated sludge and/or MLSS flow after an HDS channel that is not bifurcated. In this embodiment to control the activated sludge and/or MLSS flow to separator 2002, various data items are collected. These data items include for example, pressure, bandwidth and flow velocity. Additionally, sensors for temperature, solids concentration, and viscosity may also be used to collect desired data. Such data items are in this embodiment fed to operation controller 2014, which in turn provides control signals to input controller 2006. Thus, the presently described embodiments may include various sensing on feedback control to allow for the enhanced operation of the fluid flow. Those sensors may also be provided on the channels to detect velocity variations. This data will then be used to feedback to necessary pumps or control valves to maintain a desired constant flow rate, and hence velocity. A pressure sensor can also be provided to adjust the flow rate in channels to minimize band dispersion and to maximize flow recovery. Temperature sensors may be used to correct fluidity operation and the viscosity sensors being used to correct for adjustments in operation parameters. Solids concentration sensors may be used to adjust splitter location to assist in the distribution of solids between the aeration basin and the clarifier, providing improved process control. Feedback control may also be employed to trigger cleaning routines.

Turning now to particular operation characteristics, while wastewater treatment plants may have distinct operational characteristics to which the present concepts may be applied embodiments described herein are intended to be configured to at least operate within flow rates per channel of 0.2 to 2 liters per minute (0.865 L/min typical), where an HDS channel design might have a typical cutoff size (minimum separable particle size) of 20-200 μm (100 μbeing the typical cutoff size). The largest intended particle size might be in the range of 0.1 mm-1 mm (with 0.4 mm being the typical largest particle size). The HDS channels are in certain embodiments considered to have a radius of curvature of between 100 to 1000 mm (with about 285 mm being a typical curvature). It is also noted that the starting solid concentration (i.e., activated sludge and/or MLSS) is in the range of 100-10,000 mg/L (with 3000 mg/L being a typical concentration). In addition, the operating pressure (psi) within the system is in the range of 10 psi to 0.1 psi (with 0.6 psi being a typical operating pressure). The foregoing are perceived by the inventors as the ranges that are intended to be used in systems such as being described herein. More particularly, a specific design that has been specifically tested, includes the following characteristics: flow rate per channel is 600 ml/min, with a particle cutoff size being approximately 70 μm, with the largest particle size being approximately 0.25 mm, with the channels having a radius of curvature of approximately 198 mm (having starting/inlet concentrations that have been tested being between 2000 and 9000 mg/L), and the system having an operating pressure of approximately 1.2 psi (which can be provided by approximately a 3 foot elevation raise). It is understood that the larger the channels of an HDS arrangement the lower the pressure needed to have wastewater flow through the system. With regard to the particles in the wastewater, a particular ratio is that the HDS channel height is approximately four (4) times the size of the largest particles in a solution, and the HDS channel width is between approximately four (4) to twenty (20) times the HDS channel height.

It is to be appreciated that variants of the above-disclosed and other features and functions, or alternatives thereof, may be desirably combined into many other different systems or applications. Also, that the various presently unforeseen or unanticipated alternatives, modifications, variations or improvements therein may be subsequently made by those skilled in the art which are also intended to be encompassed by the following claims.

What is claimed is:

1. A method of processing wastewater through a wastewater treatment plant comprising:
providing wastewater to an aeration basin configured to receive the wastewater;
producing suspended-growth biomass, including at least one of activated sludge and mixed liquor suspended solids (MLSS) that is enriched for and collected within the aeration basin and clarifier system and used to degrade constituents in the wastewater;
passing portions of the activated sludge and/or MLSS from the aeration basin over a weir;
providing an aeration basin effluent channel positioned in operational association to the weir, and configured to receive the activated sludge and/or MLSS coming over the weir from the aeration basin;
receiving the activated sludge and/or MLSS from the aeration basin effluent channel into inputs of a hydrodynamic separator (HDS) arrangement in operative connection with the aeration basin effluent channel, the HDS arrangement including a plurality of individual curved channels, formed as a stack of the individual curved channels operative to generate flow fields comprising first portions and second portions of the activated sludge and/or MLSS;
outputting the activated sludge and/or MLSS from the HDS arrangement via HDS output openings;
splitting the activated sludge and/or MLSS at the HDS output openings by a splitter plate positioned at or within the output openings of the HDS arrangement for directing the activated sludge and/or MLSS, the first portion flowing to a concentrate channel and the second portion flowing to an effluent channel;
re-cycling the activated sludge and/or MLSS in the concentrate channel back to the aeration basin or an aeration influent channel; and
processing the activated sludge and/or MLSS of the effluent channel forward for further clarification operations.

2. The method of claim 1 wherein the aeration basin effluent channel includes an output for passing the activated sludge and/or MLSS received therein out of the aeration basin effluent channel.

3. The method according to claim 1 further including providing the operative connection between the HDS arrangement and the aeration basin effluent channel at a bottom surface of the aeration basin effluent channel.

4. The method according to claim 1 further including providing the operative connection between the HDS arrangement and the aeration basin effluent channel at a side wall of the aeration basin effluent channel, the operative connection being made such that the position of the stack of HDS channels is sufficiently below the water surface level in the aeration basin to provide the desired pressure to drive flow through the HDS arrangement at the desired velocity

5. The method according to claim 1 further including positioning the HDS arrangement external to the concentrate channel and the effluent channel, with the input openings and the output openings of the HDS arrangement located above the curved portion of the channels.

6. The method according to claim 1 further including positioning the HDS arrangement external to the concentrate channel and the effluent channel, with the input openings and output openings of the HDS arrangement are located below the curved portion of the channels.

7. The method according to claim 1 further including positioning the HDS arrangement submerged within at least one of the concentrate channel and the effluent channel, with the input openings and output openings of the HDS arrangement are located below the curved portion of the channels.

8. The method according to claim 1 further including positioning a splitter arrangement within an operational distance to the output openings to move the activated sludge and/or MLSS flow from the output openings into the concentrate channel and the effluent channel, the splitter being moveable along the face of the output openings and removable from the operational distance.

9. The method according to claim 8 further including cleaning the splitter by use of an automated brush cleaning mechanism while the splitter remains in the operational distance.

10. The method according to claim 8 further including cleaning the splitter by automatically raising and lowering the splitter through a brush cleaning mechanism.

11. The method according to claim 1 further including sensing water levels in at least some of the HDS arrangement, the concentrate channels and the effluent clear channels, by use of a sensor.

12. The method according to claim 1 further including sensing suspended solids concentrations in at least some of the HDS arrangement, the concentrate channels and the effluent clear channels, by use of a sensor.

13. The method according to claim 1 further including sensing turbidity in at least some of the HDS arrangement, the concentrate channels and the effluent clear channels, by use of a sensor.

14. The method according to claim 11 wherein the sensor arrangement includes sensors positioned by or within selected ones of the HDS channels and a sensor controller arrangement to receive signals generated by the sensors.

15. A wastewater treatment plant incorporating a particle separation device comprising:
an aeration basin having an input configured to receive wastewater;
a weir for directing the activated sludge and/or MLSS from the aeration basin;
an aeration basin effluent channel positioned in approximate association to the weir to receive at least one of activated sludge and MLSS coming over the weir from the aeration basin;
a hydrodynamic separator (HDS) arrangement including a plurality of curved channels having inputs configured to receive the activated sludge and/or MLSS from the aeration basin effluent channel output and a plurality of outputs, the HDS arrangement formed as a stack of individual channels operative to generate flow fields comprising first portions and second portions, the first and second portions of the flow field being formed by flow drive forces generated by the flow field in the curved channels, the flow driven forces including centrifugal forces and at least low pressure forces or buoyancy forces; and
a splitter mechanism positioned at or within the output openings of the HDS arrangement channels for directing a split of the activated sludge and/or MLSS such that the first portion flows on a first path and the second portion flows on a second path.

16. The plant of claim 15 wherein the aeration basin effluent channel includes an output for the activated sludge and/or MLSS received therein.

17. The plant according to claim 15 further including the operative connection between the HDS arrangement and the aeration basin effluent channel is provided at a bottom surface of the aeration basin effluent channel.

18. The plant according to claim 15 further including the operative connection between the HDS arrangement and the aeration basin effluent channel is provided at a side wall of the aeration basin effluent channel, the operative connection being such that the position of the stack of HDS arrangement is sufficiently below the water surface level in the aeration basin to provide the desired pressure to drive flow through the HDS arrangement at the desired velocity.

19. The plant according to claim 15 further including the HDS arrangement positioned external to the concentrate channel and the effluent channel, with the input openings and the output openings of the HDS arrangement located above the curved portion of the channels.

20. The plant according to claim 15 further including the HDS arrangement positioned external to the concentrate channel and the effluent channel, with the input openings and output openings of the HDS arrangement located below the curved portion of the channels.

21. The plant according to claim 15 further including the HDS arrangement positioned within at least one of the concentrate channel and the effluent clear channel, with the input openings and output openings of the HDS arrangement located below the curved portion of the channels.

22. A method of processing wastewater through a wastewater treatment plant comprising:
providing wastewater to an aeration basin configured to receive the wastewater;
producing suspended-growth biomass, including at least one of activated sludge and mixed liquor suspended solids (MLSS) that is enriched for and collected within the aeration basin and a clarifier system and used to degrade constituents in the wastewater;
passing portions of at least one of activated sludge and MLSS from the aeration basin over a weir;
providing an aeration basin effluent channel positioned in operational association to the weir, and configured to receive the activated sludge and/or MLSS coming over the weir from the aeration basin;
receiving the activated sludge and/or MLSS from the aeration basin effluent channel into inputs of a hydrodynamic separator (HDS) arrangement in operative connection with the aeration basin effluent channel, the HDS arrangement including a plurality of individual curved channels, formed as a stack of the individual curved channels operative to generate flow fields comprising first portions and second portions of the activated sludge and/or MLSS, the first and second portions of the activated sludge and/or MLSS flow being formed by flow drive forces generated by flow fields in the curved channels, the flow driven forces including centrifugal forces and at least low pressure forces or buoyancy forces and the activated sludge and/or MLSS being passed through the curved channels of the HDS arrangement by at least one of gravitational forces and hydrostatic pressure of the aeration basin effluent channel and the inputs of the HDS arrangement;
outputting the activated sludge and/or MLSS from the HDS arrangement via HDS output openings;
splitting the activated sludge and/or MLSS at the HDS output openings by a splitter mechanism positioned at or within the output openings of the HDS arrangement for directing a split of the activated sludge and/or MLSS, the first portion flowing to a concentrate channel on a first path and the second portion flowing to a effluent channel on a second path;
re-cycling the activated sludge and/or MLSS in the concentrate channel back to the aeration basin or an aeration influent channel; and
processing the activated sludge and/or MLSS of the effluent channel forward for further clarification operations.
